(19) United States
(12) Patent Application Publication
(10) Pub. No.: US 2013/0227008 A1
(43) Pub. Date: Aug. 29, 2013

(54) CLOCK SYNCHRONIZATION BASED ON PREDEFINED GRANDMASTER

(71) Applicant: Yang Yang, Cupertino, CA (US)

(72) Inventor: Yang Yang, Cupertino, CA (US)

(73) Assignee: CISCO TECHNOLOGY, INC., San Jose, CA (US)

(21) Appl. No.: 13/406,179

(22) Filed: Feb. 27, 2012

(51) Int. Cl. G06F 1/12; G06F 15/16

(52) U.S. Cl. 709/204

(57) ABSTRACT

In one embodiment, a method includes storing a grandmaster candidate list at a precision time protocol device, receiving a message identifying a synchronization hierarchy for use in clock synchronization at the precision time protocol device, the synchronization hierarchy having a grandmaster, determining if the grandmaster identified in the message is on the grandmaster candidate list, and performing synchronization in accordance with the synchronization hierarchy at the precision time protocol device if the grandmaster identified in the message is on the grandmaster candidate list. An apparatus is also disclosed.

### TECHNICAL FIELD

The present disclosure relates generally to communication networks, and more particularly, to clock synchronization in a computer network.

### BACKGROUND

Precise time synchronization in a computer network is needed for many network applications. IEEE 1588 (Standard for a Precision Clock Synchronization Protocol for Networked Measurement and Control Systems) defines a Precision Time Protocol (PTP) for use in synchronizing clocks throughout communication networks. The IEEE 1588 standard describes a hierarchical master-slave architecture comprising one or more network segments and clocks. A synchronization master is selected for each of the network segments. A root timing reference called a grandmaster transmits synchronized timing information to the clocks residing on its network segment. PTP network devices with a presence on that segment then relay synchronized timing information to the other segments to which they are connected.

### BRIEF DESCRIPTION OF THE FIGURES

FIG. 1 illustrates an example of a network in which embodiments described herein may be implemented.

FIG. 2 depicts an example of a network device useful in implementing embodiments described herein.

FIG. 3 is a flowchart illustrating an overview of a process for selecting a grandmaster for use in clock synchronization, in accordance with one embodiment.

Corresponding reference characters indicate corresponding parts throughout the several views of the drawings.

### DESCRIPTION OF EXAMPLE EMBODIMENTS

### Overview

In one embodiment, a method generally comprises storing a grandmaster candidate list at a precision time protocol device, receiving a message identifying a synchronization hierarchy for use in clock synchronization at the precision time protocol device, the synchronization hierarchy comprising a grandmaster, determining if the grandmaster identified in the message is on the grandmaster candidate list, and performing synchronization in accordance with the synchronization hierarchy at the precision time protocol device if the grandmaster identified in the message is on the grandmaster candidate list.

In another embodiment, an apparatus generally comprises memory for storing a grandmaster candidate list, a processor for processing a message indicating a synchronization hierarchy for use in clock synchronization, the synchronization hierarchy comprising a grandmaster, and searching the grandmaster candidate list for the grandmaster identified in the message, and a synchronization module for performing synchronization in accordance with the synchronization hierarchy if the grandmaster identified in the message is on the grandmaster candidate list.

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

Precision Time Protocol (PTP) is used to define how real-time clocks in a networked system synchronize with one another. The clocks are organized in a master-slave synchronization hierarchy with the clock at the top of the hierarchy, a grandmaster, determining the reference time for the system. All clocks within a PTP domain are synchronized based on the grandmaster clock. In conventional PTP systems, a grandmaster is selected using a best master clock (BMC) algorithm. The BMC algorithm performs a distributed selection of the best candidate clock based on a clock identifier, quality, priority, and variance. A master is selected for each network segment in the domain. PTP devices in the network exchange timing messages, with the slaves using the timing information to adjust their clocks to the time of their master in the hierarchy. In one example, the master and slave clocks trade synchronization packets and timestamp the transmissions. The difference between the synchronization packet's departure and arrival timestamps is used to calculate an offset between the slave and their master. The slave clock uses the offset to bring itself into agreement with its master.

In conventional PTP systems, any root timing reference clock can be selected as the grandmaster. This results in a number of challenges, including security and manageability issues. For example, a clock may be inserted into the network with an artificially high priority to claim the grandmaster role and interrupt operation of the PTP network. This may be done intentionally to harm the network or unintentionally by a misconfigured device or operator error. In some cases, the BMC algorithm may elect a grandmaster that is not within control of a PTP network team. For example, a clock source may be provided by service providers that the network team does not have control over. There is, therefore, a need for a way to define a grandmaster or grandmaster candidates to provide further control with respect to selection of the grandmaster for both security and manageability reasons.

The embodiments described herein may be used to implement a predefined grandmaster candidate list to control selection of the clock that can be elected as the grandmaster in a PTP network. The term ‘grandmaster’ as used herein may refer, for example, to an IEEE 1588 grandmaster clock that can be used as a root or source timing reference for synchronizing clocks in a computer network. The term ‘synchronization hierarchy’ as used herein refers to a hierarchy that includes the grandmaster operating as a source timing reference for a precision time protocol system. The term ‘precision time protocol (PTP) device’ may refer to any network device that implements the PTP protocol stack and participates in the PTP message exchange to deliver the PTP timing synchronization in a communication network. As described below, the PTP device may be a device that operates according to IEEE 1588 PTP protocol.

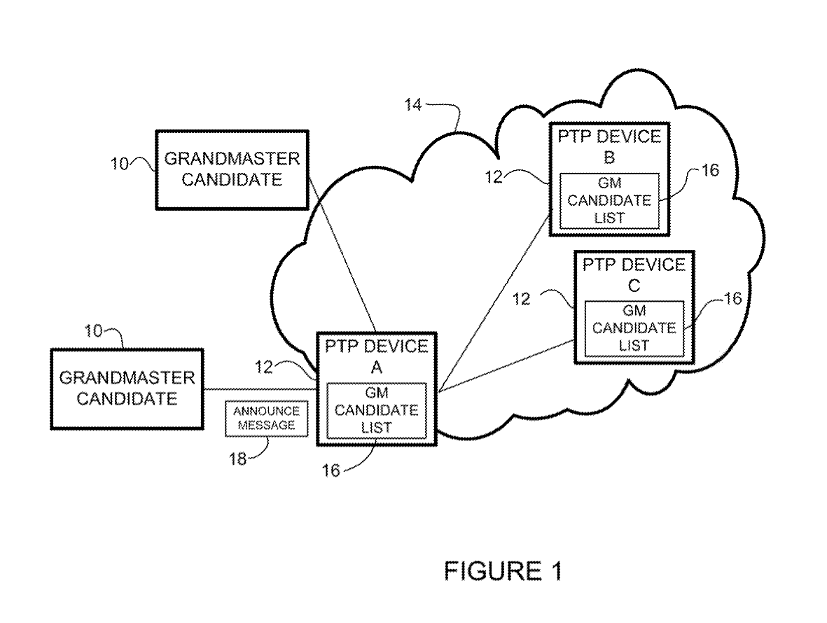

Referring now to the drawings, and first to FIG. 1, a network in which the embodiments described herein may be implemented is shown. For simplification only a small number of nodes are shown. The network comprises a distributed networked system of PTP devices 10, 12 (e.g., devices comprising ordinary clocks or boundary clocks) and non-PTP devices (not shown). In one embodiment, the PTP system operates in accordance with IEEE 1588 (IEEE Standard for a Precision Clock Synchronization Protocol for Networked Measurement and Control Systems, Jul. 24, 2008).

Devices 10, 12 in the PTP system communicate with one another via a communication network 14. The network 14 may include one or more networks (e.g., local area network, metropolitan area network, wireless local area network, wide area network, satellite network, enterprise network, Internet, intranet, radio access network, public switched network, virtual private network, or any other network). Communication paths between the PTP network devices 10, 12 may include any number or type of intermediate nodes (e.g., routers, switches, gateways, or other network devices), which facilitate passage of data between the network devices.

In the example shown in FIG. 1, the PTP system includes two grandmaster candidate devices 10. Either of these network devices 10 may be selected to operate as a grandmaster in the PTP system, as described below. The grandmaster candidate devices 10 may be, for example, a server; host, or other network device configured to operate as a grandmaster clock for the PTP system. The grandmaster clock determines the timescale and related timescale properties of the domain. The system shown in FIG. 1 further includes a plurality of PTP devices 12 (A, B, C). The PTP devices 12 may include, for example, switches, routers, bridges, gateways, servers, or other network devices. Synchronization of the PTP devices 12 is performed based on a synchronization hierarchy with one of the grandmaster candidates 10 at the top of hierarchy.

The PTP system may comprise, for example, one or more ordinary clock, boundary clock, end-to-end transparent clock, peer-to-peer transparent clock, or management node. An ordinary clock is a device with a single network connection and can be the grandmaster clock or a slave clock in the master-slave hierarchy. A boundary clock has multiple network connections and can bridge synchronization from one network segment to another network segment. Transparent clocks modify PTP messages as they pass through the device to correct, for time spent traversing the network equipment. The example shown in FIG. 1 includes four ordinary clocks (grandmaster candidate devices 10 and PTP devices B, C) and one boundary clock (PTP device A) interposed between the grandmaster 10 and ordinary clocks. As described below, the PTP system elects one grandmaster clock 10, which communicates with a slave port at the boundary clock (PTP device A). All other ports on the boundary clock are masters to the clocks connected thereto. Ports at PTP devices B and C are slaves to the boundary clock (PTP device A).

The network devices 10, 12 transmit PTP synchronization and control messages to one another. For example, IEEE 1588 PTP devices use Sync, Delay_Req, Follow_Up, and Delay_Resp messages to generate and communicate timing information needed to synchronize ordinary and boundary clocks using a delay request-response mechanism. Pdelay_Req, Pdelay_Resp, and Pdelay_Resp_Follow_Up messages are used to measure link delay between two clock ports implementing a peer delay mechanism. The link delay is used to correct timing information in Sync and Follow_Up messages in systems comprising peer-to-peer transparent clocks. Ordinary and boundary clocks that implement the peer delay mechanism can synchronize using the measured link delays and the information in the Sync and Follow-Up messages. The PTP devices may also transmit management and signaling messages. An announce message 18 is used to establish the synchronization hierarchy. The announce messages 18 provide status and characterization information of the transmitting node and its grandmaster. For example, the announce message 18 may include information used by the receiving node when executing the best master clock algorithm. As described in detail below, the announce message 18 includes the grandmaster identity, which is checked against a grandmaster candidate list 16 to determine if the grandmaster identified in the announce message is an acceptable candidate.

One or more of the PTP devices 12 include the predefined grandmaster (GM) candidate list 16 identifying one or more network devices that may operate as a grandmaster in the PTP domain. The grandmaster candidate list 16 may be any data structure configured so that the list can be searched for a matching device identifier. There may be only one grandmaster candidate on the list 16, or a plurality of grandmaster candidates may be defined for redundancy. The grandmaster candidate 10 may be identified, for example, by an IP (Internet Protocol) address or MAC (Media Access Control) address. The IP address may be used, for example, in a network that comprises transparent clocks so that the IP address of the grandmaster can be preserved on the last hop of the boundary clock. The IP address is the PTP source address used in the grandmaster clock.

In one embodiment, the MAC address is provided in a clockIdentity, as defined in IEEE 1588. The clockIdentity may comprise, for example, an organizationally unique identifier (OUI), and more specifically, a 64-bit Extended Unique Identifier (EUI-64). The EUI-64 identifier is formed by concatenating the 24-bit OUI with a 40-bit extension identifier that is assigned by the organization that has the OUI. The resulting identifier is generally represented as a set of octets separated by dashes (hexadecimal notation) or colons (bit-reversed notation), as a string of 8 bytes, or as a base 16 number.

In one embodiment, a statically defined grandmaster candidate list 16 is manually configured on each PTP device 12 by a network administrator, for example. The grandmaster candidate list 16 may also be generated by a node in the network (e.g., management node) and automatically distributed to the PTP devices in the network. As previously noted, the grandmaster candidate list 16 may contain one or more device identifiers.

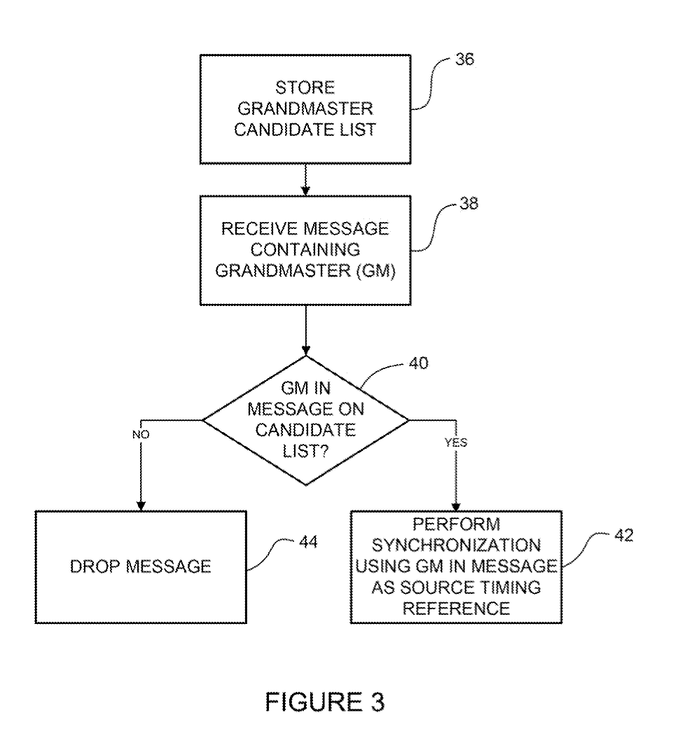

As described further below with respect to the flowchart of FIG. 3, when an announce message 18 arrives at the PTP device 12, the grandmaster identity (e.g., clockIdentity or IP address) in the message is checked against the grandmaster candidate list. If a match is found, PTP synchronization continues using the identified grandmaster clock as the clock source. If a match is not found, the announce message is dropped (ignored) and the PTP device will continue to synchronize with the previous grandmaster in accordance with a previous synchronization hierarchy, or if no grandmaster has been identified, no synchronization will be performed.

It is to be understood that the network shown in FIG. 1 and described herein is only an example and that the embodiments may be implemented in networks having different network topologies or network devices, without departing from the scope of the embodiments. For example, the network may include any number of PTP devices and network segments and may also include multiple domains, in which case each domain can have a different grandmaster candidate list.

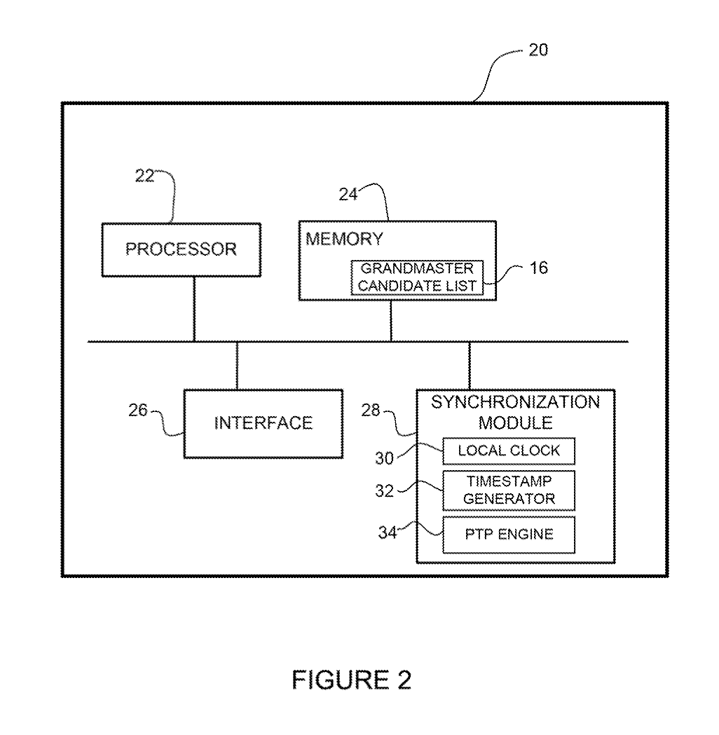

FIG. 2 illustrates an example of a network device 20 (e.g., precision time protocol device) that may be used to implement the embodiments described herein. In one embodiment, the network device 20 is a programmable machine that may be implemented in hardware, software, or any combination thereof. The network device 20 includes one or more processor 22, memory 24, network interface 26, and synchronization module 28.

Memory 24 may be a volatile memory or non-volatile storage, which stores various applications, operating systems, modules, and data for execution and use by the processor 22. Memory 24 may be used to store the grandmaster candidate list 16, timestamps, or PTP state, for example.

Logic may be encoded in one or more tangible media for execution by the processor 22. For example, the processor 22 may execute codes stored in a computer-readable medium such as memory 24. The computer-readable medium may be, for example, electronic (e.g., RAM (random access memory), ROM (read-only memory), EPROM (erasable programmable read-only memory)), magnetic, optical (e.g., CD, DVD), electromagnetic, semiconductor technology, or any other suitable medium.

The network interface 26 may comprise any number of interfaces (e.g., linecards, ports) for receiving data or transmitting data to other devices. The interface 26 may include, for example, an Ethernet interface for connection to a computer or network.

In one embodiment, the synchronization module 28 includes a local clock 30, timestamp generator 32, and PTP engine 34. The local clock 30 is synchronized with the grandmaster clock, which may comprise synchronizing with another master (e.g., boundary clock) in the synchronization hierarchy. The timestamp generator 32 is used to timestamp synchronization messages transmitted to and received from other PTP devices. The timestamps are generated from the local clock 30. The PTP engine 34 sends and receives PTP messages and executes the state machine associated with a port. If the port is in a slave state (synchronizes to a master), the PTP engine computes the master's time based on the received PTP timing messages and timestamps that were generated and adjusts its clock accordingly.

It is to be understood that the network device 20 shown in FIG. 2 and described above is only an example and that different configurations of network devices may be used. For example, the network device 20 may further include any suitable combination of hardware, software, algorithms, processors, devices, components, or elements operable to facilitate the capabilities described herein.

FIG. 3 is a flowchart illustrating an overview of a process for selecting a grandmaster for use in clock synchronization, in accordance with one embodiment. At step 36, the PTP network device 12 stores a grandmaster candidate list 16. As described above, the list may contain one or more network devices that are acceptable for use as a grandmaster clock within the PTP domain. The grandmaster candidate list 16 may be, for example, manually configured at the device 12. The PTP device 12 receives a message (e.g., announce message 18) identifying a synchronization hierarchy (step 38). The synchronization hierarchy comprises a grandmaster and other information used to establish a master-slave hierarchy (e.g., data for use in best master clock algorithm). The PTP device 12 searches the grandmaster candidate list 16 for the grandmaster identified in the announce message (step 40). If a match is found, the device 12 performs synchronization in accordance with the synchronization hierarchy specified in the announce message (e.g., PTP device synchronizes with grandmaster in announce message or other master in hierarchy) (step 42).

If a match is not found, the PTP device 12 drops (ignores) the announce message (step 44) and the PTP device continues to synchronize with the previous grandmaster, or if no grandmaster has been identified, no synchronization will be performed (e.g., clock assumes it is a master clock or port is in passive state in which the port does not synchronize to master). In one example, the best master clock algorithm is used to determine whether a newly discovered clock (foreign master) is better than the local clock. The data describing the foreign master is contained in the grandmaster field of the announce message. If the newly discovered clock is not on the grandmaster candidate list, it cannot be selected for use as a grandmaster clock at the PTP device.

It is to be understood that the process shown in FIG. 3 and described above is only an example and that steps may be added, modified, or combined, without departing from the scope of the embodiments.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

What is claimed is:

1. A method comprising:
storing a grandmaster candidate list at a precision time protocol device;
receiving a message identifying a synchronization hierarchy for use in clock synchronization at the precision time protocol device, said synchronization hierarchy comprising a grandmaster;
determining if the grandmaster identified in said message is on the grandmaster candidate list; and
performing synchronization in accordance with said synchronization hierarchy at the precision time protocol device if the grandmaster identified in said message is on the grandmaster candidate list.

2. The method of claim 1 wherein the grandmaster candidate list comprises at least one network device operable as a source timing reference.

3. The method of claim 1 wherein the grandmaster candidate list comprises one or more addresses of network devices operable as a source timing reference.

4. The method of claim 1 wherein one or more of the grandmasters in the grandmaster candidate list is identified by a clockIdentity value.

5. The method of claim 1 wherein storing a grandmaster candidate list comprises manually configuring the precision time protocol device.

6. The method of claim 1 wherein receiving a message comprises receiving an announce message.

7. The method of claim 1 wherein the precision time protocol device comprises a network device operating in accordance with IEEE 1588 standard.

8. The method of claim 1 further comprising performing synchronization in accordance with a previously defined synchronization hierarchy comprising a grandmaster on the grandmaster candidate list if the grandmaster identified in said message is not on the grandmaster candidate list.

9. An apparatus comprising:
memory for storing a grandmaster candidate list;
a processor for processing a message indicating a synchronization hierarchy for use in clock synchronization, said synchronization hierarchy comprising a grandmaster, and searching the grandmaster candidate list for the grandmaster identified in said message; and
a synchronization module for performing synchronization in accordance with said synchronization hierarchy if the grandmaster identified in said message is on the grandmaster candidate list.

10. The apparatus of claim 9 wherein the grandmaster candidate list comprises at least one network device operable as a source timing reference.

11. The apparatus of claim 9 wherein the grandmaster candidate list comprises one or more addresses of network devices operable as a source timing reference.

12. The apparatus of claim 9 wherein said message comprises an announce message.

13. The apparatus of claim 9 wherein the synchronization module is configured to perform synchronization in accordance with a previously defined synchronization hierarchy comprising a grandmaster on the grandmaster candidate list if the grandmaster identified in said message is not on the grandmaster candidate list.

14. The apparatus of claim 9 wherein the processor is configured to drop said message if the grandmaster identified in said message is not on the grandmaster candidate list.

15. The apparatus of claim 9 wherein the apparatus is manually configured with the grandmaster candidate list.

16. An apparatus comprising:
memory for storing a grandmaster candidate list;
means for processing a message identifying a synchronization hierarchy for use in clock synchronization, said synchronization hierarchy comprising a grandmaster, and determining if a grandmaster identified in said message is on said grandmaster candidate list; and
means for performing synchronization in accordance with said synchronization hierarchy if the grandmaster identified in said message is on the grandmaster candidate list.

17. The apparatus of claim 16 wherein the grandmaster candidate list comprises one or more Internet Protocol addresses of network devices operable as a source timing reference.

18. The apparatus of claim 16 wherein the grandmaster candidate list comprises one or more media access control addresses of network devices operable as a source timing reference.

19. The apparatus of claim 16 wherein said message comprises an announce message.

20. The apparatus of claim 16 further comprising means for performing synchronization in accordance with a previously defined synchronization hierarchy comprising a grandmaster on the grandmaster candidate list if the grandmaster identified in said message is not on the grandmaster candidate list.
